(19) United States
(12) Patent Application Publication
(10) Pub. No.: US 2015/0363817 A1
(43) Pub. Date: Dec. 17, 2015

(54) Method and System for Online Audience Development and Advertising

(71) Applicant: Rome Viharo, Los Angeles, CA (US)

(72) Inventor: Rome Viharo, Los Angeles, CA (US)

(21) Appl. No.: 14/302,424

(22) Filed: Jun. 12, 2014

(51) Int. Cl. G06Q 30/02; H04N 21/658

(52) U.S. Cl. CPC G06Q 30/0239; H04N 21/6582

(57) ABSTRACT

This invention is a method and system of audience delivery for content providers to build or share their audiences directly with content creators. A mobile video and audience engagement product connects content creator platforms and content provider platforms. This invention provides a quantifiable high quality discovery and appeal for the audience of content providers, to the specifications of content creators who seek to acquire audience attention from content providers. The invention integrates and delivers to content providers and content creators a simultaneous, mutual, and measurable value previously unavailable. The invention delivers unique data metrics. The invention allows discovery and distribution of multi-channel and multi-content distribution, with a numerical score for how appealing a campaign is to viewers.

### BACKGROUND

The present invention is for content discovery by online audiences using mobile media devices and desktop computers. Specifically, a content provider using the invention can deliver or obtain audience visits, views, clicks, plays, and impressions inside a particular manner of content discovery.

The marketplace in this field is defined in this application as the relationship between content publishers or distributors of mobile and desktop sites and mobile apps, and content creators who seek those publishers and distributors.

On the World Wide Web, interstitials are usually web pages displayed before or after an expected content page. For example, interstitials are used to display advertisement or confirm the user's age (e.g. prior to showing age-restricted material). Most interstitial advertisements are delivered by an ad server. Full-screen interstitial ads are referred to as hyperstitials.

Alternative uses of interstitial pages include introducing another page or site before directing the user to proceed; or alerting the user that the next page requires a login, or has some other requirement which the user should know about before proceeding. Currently, content creators offer video to online audiences. Primarily, these audiences are acquired through display clicks that lead to video landing pages, in-banner video display units, autoplay interstitials or in-stream, or reward-based media such as online social games that are played on the Facebook Corp website and various platforms. Also, during the dot com years (1995-2001), websites like Cybergold.com, Beenz.com and flooz.com had rewards-based marketing. Visitors to a website would view content provided by advertisers, and get credit in the site's currency which might then be converted to real currency or spent in other ways.

### SUMMARY OF THE INVENTION

The present invention provides an improvement and an add-on to existing data processing systems for online audience development. The invention is a specialized mobile video distribution system and method for the discovery of clicks, impressions, initializations or views to an online video. It delivers new engagement options, data, and media-planning for advertising, promotional, or audience-development transactions between content providers.

In one embodiment, the improvement on the data processing systems is comprised of at least 1 Viewer Interface (VI) unit for video viewing through mobile distribution across mobile sites and apps. Another embodiment provides a specific method for content and media planning, reporting, and sensemaking around new data furnished by the invention.

The scope of the invention would not be limited to these specific examples and includes, as would be appreciated by those skilled in the art, many others.

In another embodiment, a basic video player (“Basic Player”) can wrap any video, including YouTube® videos, into an autoplay or ‘click-to-play view’ environment. This provides social sharing site call-ins and direct response objects. The objects can appear upon video completion or any partial completion (e.g. quartile completion) of video, customizable overlays, or video playlists. The objects can be embedded on to any desktop or mobile site. The Basic Player can record impressions to any page where the video is placed, in addition to recording audience behavioral data such as clicks, session quartiles and completions, and sharing. The scope of the invention would not be limited to these specific examples and includes, as would be appreciated by those skilled in the art, many others.

In another embodiment, a video unit embedded natively on a publisher page is discovered through clicks on a publisher site, and the viewer may be asked to ‘press play to continue’ to the content. The screen may lock for a few seconds (for example about 5 seconds) upon video activation and user can leave the unit any time thereafter via a publisher link in an easy to discover fashion for the user. The scope of the invention would not be limited to these specific examples and includes, as would be appreciated by those skilled in the art, many others.

In another embodiment, the video unit becomes a distribution product for ‘Appealing Pathways of Discovery’ of additional content that is meaningful to the advertising or promoting party. The scope of the invention would not be limited to these specific examples and includes, as would be appreciated by those skilled in the art, many others.

In yet another embodiment, the content discovery by viewers directly attributable to mobile publisher audiences is planned through the method of the invention. Campaign completion is reported through the sensemaking template, letting content creators cultivate an annual brand audience. The scope of the invention would not be limited to these specific examples and includes, as would be appreciated by those skilled in the art, many others.

The invention may offer the following for content providers:

For Content Publishers:

A] Mobile publishers can furnish audiences, using native presentations, to content creators.
B] Publishers have various ways for viewers to discover content.
C] Viewers can navigate content, and any necessary accompanying media that hosts that content, without leaving the mobile publisher site on which they discovered that content.
D] Mobile publishers can command a high Cost Per Thousand Impressions (CPM) as well as participate in a low Cost Per View (CPV) marketplace as a benefit of adopting the invention.

For Content Creators:

a] Ability to quantify high quality and high volume discovery of content with the benefit of low cost per view video clicks through Native Unlock CPM to CPV conversion
B] Distribution of a content discovery conversion funnel along with a content discovery planning template and method
C] Direct to publisher attribution for each instance of content discovery
D] New data and measurements segmented by existing data processing dashboards for geolocation, screen, and device, including a reporting and sensemaking template
E] Cross channel optimization for the performance of content discovery through social media, public relations, and paid media
F] Premier discovery of content
G] Audience cultivation, targeting, and tracking for online video comparisons with TV media market advertising expenditures

### BRIEF DESCRIPTION OF THE DRAWINGS

FIG. 1 shows a Reward Media Platform (RMP).

FIG. 2 shows an advertiser view of the RMP.

FIG. 3 shows a user playing a game and watching a video.

FIG. 4 shows the top-level modules.

FIG. 5 shows Sensemaking.

FIG. 6 shows a Basic Player.

FIG. 7 shows a Native Unlock user interface.

FIG. 8 shows Native Unlock interacting with external elements.

### DETAILED DESCRIPTION OF THE PREFERRED EMBODIMENT

As used in this specification and in the claims, the following terms have the definitions given below:

Attribution: The location disclosure of the content discovery. Specifically, the URL of the publisher where the discovery of any potential video click, impression or initialization inside of the invention has occurred and any data related to the audience of that publisher in the discovery.

Audience: Viewers of online media, including but not limited to text, graphics, video, or any other form existing now or in the future, whether active users, or passive viewers, who are sought by content creators or publishers for any purpose.

Audience Development: The capability or intention of any content creator to acquire viewer data on any interested viewer who discovers the content through Appealing Pathways of Discovery as defined by the invention for the purposes of re-messaging, or retargeting them with future content. Audience Development lets any content creator develop a genuine Audience.

Content Creator: Any producer or developer of any form of media, including video, text, or graphic images, who wants an Audience for that media for any reason.

CPA: Cost Per Action is a transactional term used by content creators to quantify a specific type of Audience engagement, which measures the cost per defined action item by an Audience member.

CPI: Cost Per Initialization is a transactional term used by Content Creators to quantify a specific type of Audience engagement, which measure the cost per instance that an Audience member initializes a viewing of a specific media item.

CPM: Cost Per Thousand Impressions is a transactional term used by Content Creators to quantify a specific type of Audience engagement, which measures the cost per one thousand impressions by Audience members.

CPV: Cost Per View is a transactional term used by Content Creators to quantify a specific type of Audience engagement, which measures the cost per view of by Audience member.

Conversion Funnel: Any potential content used in a media plan to acquire an Audience for the content.

Data storage: memory, components, devices and media that retain digital computer data used for computing for some interval of time.

Desktop: Any extension of the invention provided to Content Creators that lets the invention be distributed to desktop screens independently of the mobile Audience.

Discovery Appeal: A measurable level of ‘appeal’ the content has for each instance of discovery.

Discovery Efficiency: A measurement of the relative amount of time, work, or effort required for appealing discovery of content.

Engagement: The measurable behavior of the online viewer while the viewer is discovering the content through the invention. Engagement includes but is not limited to commenting on content, sharing of content, clicks to links or locations of content, sign ups, initializations, survey participations, downloads, or purchases of content.

ICF Score: The data measurements derivable from data processing systems improved by the invention and the data acquired through the media buying platforms, or any potential Demand Side Platform (DSP), Supply Side Platform (SSP), Software Development Kit (SDK), and the publishers who host the invention.

Media Buying Dashboard: Any data processing systems, including potential DSP (Demand Side Platform), SSP (Supply Side Platform) or any dashboard that is used for the acquisition of advertising inventory or mediation thereof for content providers. This includes any mediation platforms or RTB (Real Time Bidding Platforms) or any technology that generates an ad tag.

Media Planning: Any content strategy, abstraction, or concept for acquiring an Audience for any form of content.

Mobile: Any potential screen, operating system, device, including tablets or phones, where the discovery of the invention occurs.

Monetization: The method of the invention that lets publishers provide content to their mobile Audience in ways previously unavailable, and deliver that discovery to another content provider.

Multi Channel: Here, ‘channel’ refers to distinct content opportunities through various forms of media and content promotional services, such as social media, ‘Public Relations’, ‘Outreach’ and ‘Paid Media’. Multi Channel is the combination of paid media and outreach media.

Native: Any potential presentation of the invention that appears to be engaging the viewer as an extension of the publisher platform, where discovery of the invention occurs.

Official Social Host: An ‘online influencer’ or internet celebrity or any influential individual who creates content online and who is active in social networks and/or blogging and whose activity can be integrated into the invention.

Online Video Promotion: All potential advertising, marketing, or public relations campaigns that may use various applications of ‘video’ for promotion. These applications include ‘social video’, ‘viral video’, ‘pre-roll video’, ‘brand-awareness video’, ‘branded entertainment video’, and ‘TV commercial’ video.

Online Viewer: Any potential Audience or discoverer of any potential mobile website or mobile app to whom a publisher offers promotional content.

Paid Content: Any content or media inventory that is purchased on a CPM, CPV, CPI, CPA or any similar metric that is priced in advertising promotional spaces by content providers. This includes cost per number of impressions, cost per number of views, cost per number of downloads, installations, direct responses, or sign ups.

Publishers and Supply Agents: Any potential publisher of any mobile site or mobile app. Including but not limited to news, opinion, entertainment and content sites, games, applications, or networks of any kind, in addition to any SDK, outreach or supply side platform that integrates with the invention for monetization purposes.

RTB: Real Time Bidding where online ads are sold via a programmatic and immediate auction.

SDK: A Software Development Kit that any mobile publisher may need to integrate content into its mobile app or site.

Sensemaking: The understanding of the data and reporting made available solely through the scope of the invention. This includes but is not limited to any third-party data.

Social, Public Relations, and outreach: Any marketing or promotion campaign that requires personal outreach to publishers and social networks for the purposes of natural discovery of marketed content outside of the world of direct media buying and advertising.

SSP: Supply Side Platform lets advertisers manage their inventory.

Unlock: Any capability in this invention that requires the discoverer of the content to participate for a limited time, or perform a limited action, before the viewer can consume content from a publisher. Once the viewer has done the requirements and followed the instructions of the invention, the publisher ‘unlocks’ the content for the viewer.

VAST tag or VPAID tag: These are Video Advertising Serving Template or Video Player Ad Interface Definition tags that serve advertising media, primarily auto-play or pre-roll content.

Video Views, Clicks, Actions, Impressions or Initializations: The measurable behavior of an online viewer who is consuming content on any potential mobile site or app. Used as a form of acquiring an Audience for that content.

In the following, this application refers to videos seen by end users. Another possible type of content is a series of still images. Or a set of pages where the user can fill out various sections or pick various graphic elements. The pages might constitute a questionnaire, for example. For brevity, this application will use “video” to also encompass such possibilities.

The invention is further described in the following sections:
1] Reward Media Platform
2] Supply
3] Demand
4] Media Planning and Reporting
5] Video Player
6] Native Unlock
7] Native Smart
8] Extensions

1] Reward Media Platform

A feature of this submission is that there is a supply of an Audience and a demand for an Audience. How should one match supply and demand? Supply comes from publishers of electronic games and other types of computer software applications. Publishers already have users playing those games. The games might be played as mobile apps on users' mobile devices. Or by users going to a publisher website to play a game. The users are the Audience. Demand comes from advertisers and other content creators, who typically make videos. The advertisers want people to see those videos. The Reward Media Platform is a means for the publishers and advertisers to find each other.

The scope of the invention is not limited to games and as those skilled in the art can appreciate, the scope of the invention can have many embodiments.

Note also that entities providing Supply (of an Audience) might also create content. For example, a publisher can create games. And entities providing Demand (of an Audience) might also create content. An advertiser creates a video, which is content. In this submission, to avoid confusion, Supply and Demand always refer to Supply and Demand for an Audience.

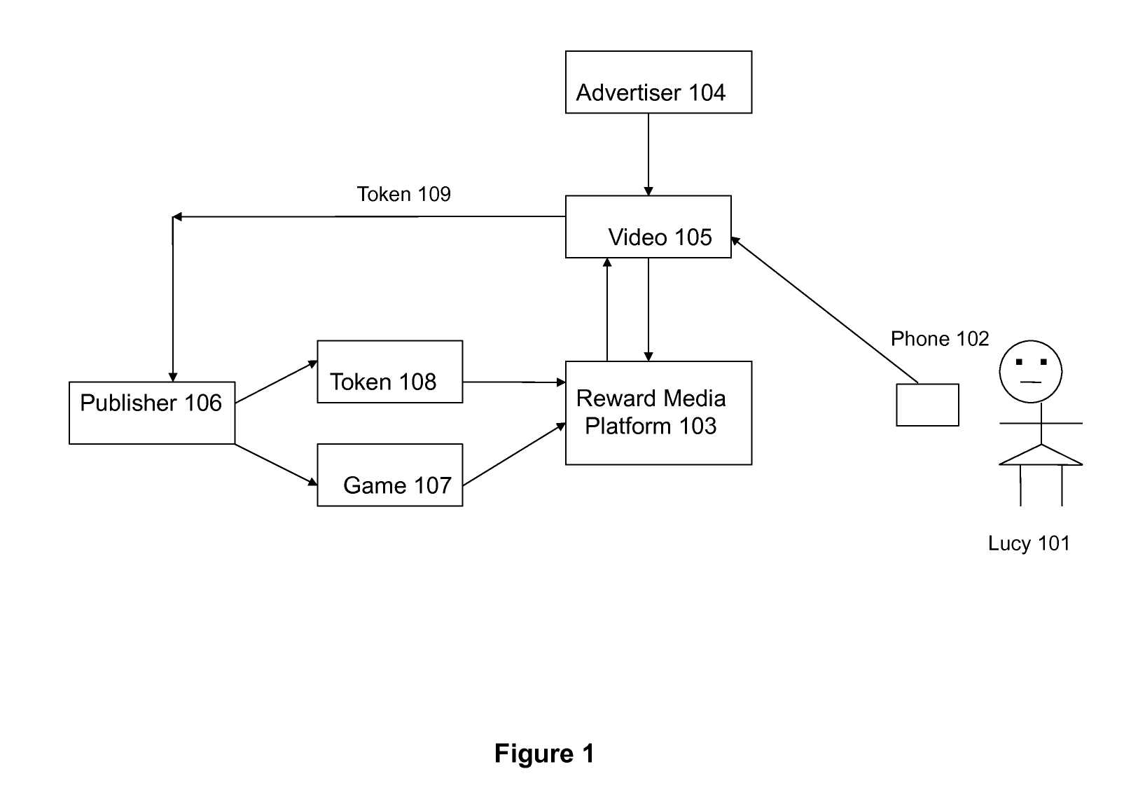

FIG. 1 shows a Reward Media Platform (RMP) 103. Publisher 106 has Game 107. Associated with this is Token 108. A token can be a type of item useful and desired by players of a game. What is a token depends on the game. For a fantasy game, this might be gold coins or some other measure of wealth or success. For a First Person Shooter (FPS) game, this might be a type of ammunition; e.g. 9 mm or 7.62 mm. Both examples essentially have a token as a scalar: a non-negative integer associated with each game.

A game might have different types of tokens. A fantasy game might also have magic potions of healing, or magic spells, or hit points, where the higher a hit point, the more likely the player is to win a combat. In other games, hit points might designate or be called experience or skill. Another type of token might be a given weapon, where the game offers a choice of weapons. If a game has different types of tokens, the tokens can be considered a vector, with each component being a given type. For simplicity in this application, take the games to have scalar tokens, without precluding vector tokens.

In later sections, this application uses the term “token exchange”. Here, “exchange” is not used in the sense of “swap” or “barter”. Rather, “token exchange” means a “marketplace” (e.g. like “New York Stock Exchange”) where tokens are bought and sold.

Publisher 106 makes Game 107 and Token 108 available on Reward Media Platform 103 for advertisers to pick. Consider Advertiser 104, who has Video 105 that needs an Audience. Advertiser 104 goes to RMP 103 and picks Game 107. It supposes that the players of Game 107 might be a good demographic fit to watch Video 105. This might be based on information furnished about Game 107 via RMP 103, or by information about the game found outside RMP 103.

Advertiser 104 buys some number of Token 108 from Publisher 106. It pays with dollars. Typically, the Reward Media Platform will take a commission from this. The commission would be in real currency, or perhaps as a quantity of the tokens.

Publisher 106 might maintain an internal record that says that Advertiser 104 now owns some number of Token 108, associated with Game 107. Likewise, Advertiser 104 could maintain an internal record that says it has bought that number of Token 108, associated with Game 107, from Publisher 106. Each side maintains its record of the transaction akin to double entry bookkeeping. Additionally, given that the Reward Media Platform brokered this transaction and took a commission, it would keep its own record.

In some games, publishers might already sell items to players. That is a way for a publisher to get revenue from a game. It “upsells” (a common preferred term) items useful in the game, directly to the player. The current submission extends this feature by giving the publisher an extra revenue source, by selling to a non-player entity (advertiser).

If a publisher sells tokens directly to a player, and to an advertiser, there is no requirement that the prices of a token be the same.

The current submission has another advantage to a publisher: not all of the tokens sold to the advertiser might ultimately be expended by users. This phenomenon is analogous to the quantity of gift cards sold by department stores compared to those redeemed by customers. It is well known that some percentage of the cards will not be spent. This excess sales of gift cards relative to those redeemed by customers is essentially, free money to the department stores. Likewise for publishers in this submission excess tokens not spent by the users are essentially free money to the advertisers.

A related feature is that the tokens sold by the publisher to an advertiser can have an expiration date. This increases the chance of some tokens never being used.

Returning to FIG. 1: at some later time, there is a user Lucy 101. She uses an electronic device to watch Video 105. This device might be a cellphone, like Phone 102. In general, it could also be any other type of electronic device. Also, it need not be her personal device. It could be a desktop computer at a cyber cafe or library, for example.

She might and probably will be induced to watch Video 105 because she will get some amount of Token 108. FIG. 1 depicts that she gets Token 109 in some manner from Reward Media Platform 103. She uses this, immediately or later, to play Game 107. In general, she might not want or need to use all of Token 109 in a given play of Game 107. Also, she might have watched other videos, from Advertiser 104 and other advertisers, that gave her tokens to Game 107. So she can accrue some amount of these tokens.

When Lucy completes seeing Video 105, RMP 103 sends Token 109, which she has just earned, and an identifier of her, to Publisher 106. The identifier might be her email address or nickname or whatever electronic label she is known to by Publisher 106, when she plays Game 107. A variant is where when she completes watching some fraction of Video 105, like a quartile, then RMP 103 sends a corresponding proportionate fraction (like a quarter) of the maximum number of Token 109 to Publisher 106.

The assumption is that she is a regular player of Game 107, and every time she plays, she first has to log into Game 107 using the same account. Thus the method of the previous paragraph has an account of hers on the publisher within which to deposit an appropriate number of tokens.

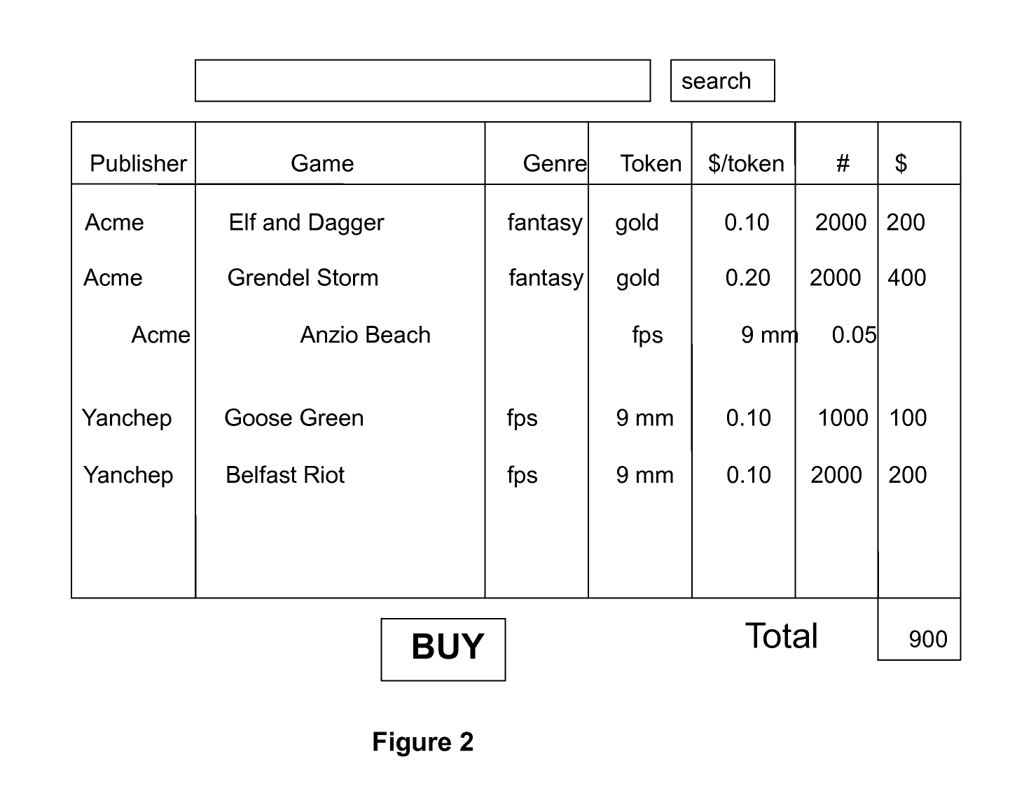

For simplicity, FIG. 1 shows only one publisher and one advertiser. In general, there will be many of both. Also, the publisher in FIG. 1 is shown to have only one game. Typically, a publisher can be expected to have several. Likewise, the advertiser is shown to have only one video. The scope of the invention is not limited to games and as those skilled in the art can appreciate, the scope of the invention can have many embodiments. FIG. 2 shows a possible graphical user interface offered to an advertiser by the Reward Media Platform. The advertiser uses this to search the games offered by publishers. It is a table. Above this table is an unmarked text field and a search button. The advertiser can type in some query, to narrow the results in the table.

The first column in the table is the name of the publisher. The next column is the title of the game, followed by a genre column, to aid the advertiser. Only two example values are shown, fantasy and fps (first person shooter). The scope of the invention is not limited to this specific example and as those skilled in the art can appreciate, the scope of the invention can have many embodiments.

The next column is the type of token. The fantasy games have the examples of gold and (magic) spell. The fps games have 9 mm ammunition. The column “$/token” means the price (in real currency) that the publisher is willing to sell one unit of each token. The scope of the invention is not limited to tokens and as those skilled in the art can appreciate, the scope of the invention can have many embodiments.

The preceding columns are read only. The column “#” (means “number”) is where the advertiser types in the amount of tokens that he wants to buy from the publisher. The $ column would then be computed automatically by the table.

Of course, other columns are possible, giving more details. And some of the columns shown in FIG. 2 might be omitted or suppressed. But the purpose of FIG. 2 should be clear to the reader.

The BUY button in FIG. 2 lets the advertiser then complete the purchase. It would go to another page where any necessary extra details are furnished, both to the advertiser and by the advertiser.

FIG. 2 is for an advertiser buying tokens for one of its videos. This explicitly lets a video have tokens from different games from different publishers.

A publisher can have a white-list of advertisers, such that it will sell tokens only to those advertisers. Alternatively, it can have a black-list of advertisers, such that it will not sell tokens to any of those advertisers. It can have both a white-list and a black-list. A publisher might want to have its games not to be associated with certain types of advertisers or products, or to be only associated with certain types of advertisers or products.

At a more fine-grained level, a publisher can have for each of its games, a white-list and a blacklist. For example, some games might be for children, so advertisers of tobacco or alcohol would not be wanted. While the publisher could have other games directed at an adult Audience, for which such restrictions are not needed.

FIG. 2 was for an advertiser to peruse possible publishers. An analogous figure would be a table of advertisers and their videos. Where an advertiser might indicate what it is willing to pay a publisher. Along with perhaps what genre of game the advertiser wants to be associated with its video. A publisher could scan this table and communicate with an advertiser.

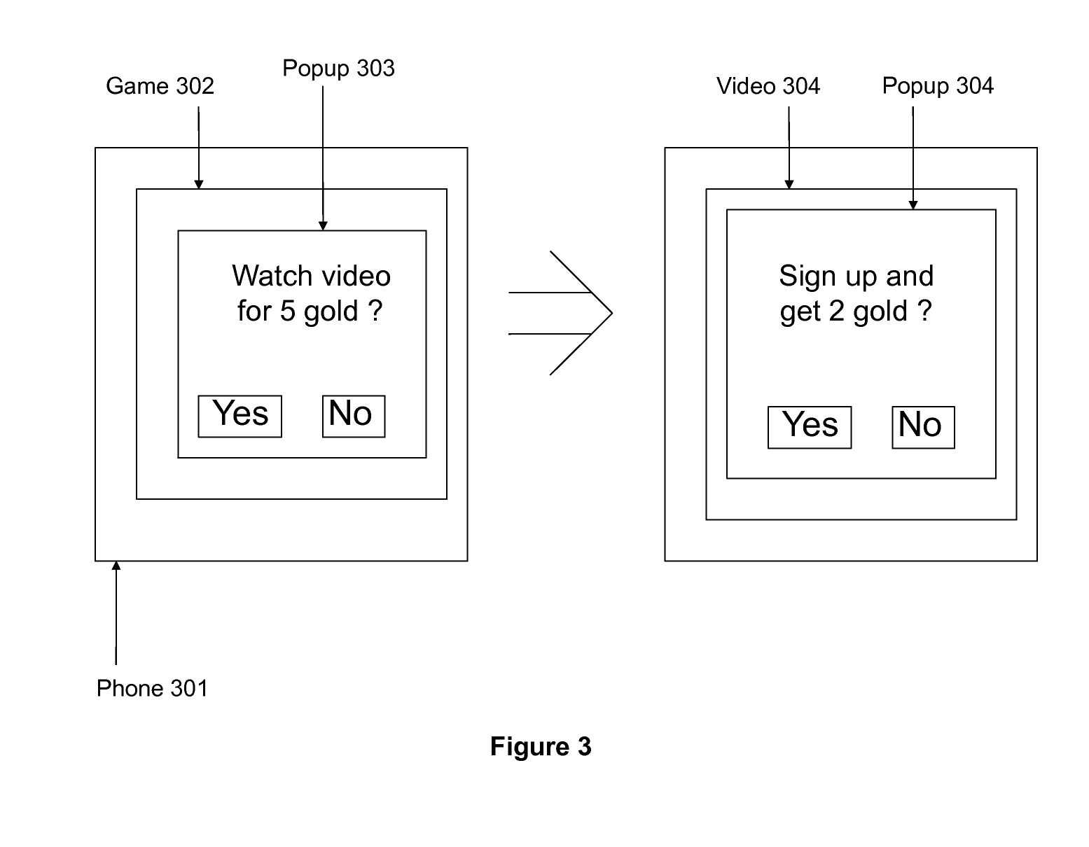

Now, consider Lucy 101. Earlier it was said that she watches Video 105, which gives her tokens to Game 107. But how does she find Video 105 in the first place? One possible way is in FIG. 3. It shows her Phone 301, and on it, she is playing Game 302. This is Game 107 of FIG. 1. By assumption, she is already playing Game 302/107. Hence having extra tokens for this game has value to her. In Game 302, there might appear Popup 303. It asks if she would like to watch a video. There are Yes and No buttons. If she picks “Yes” and watches the video, she gets 5 gold pieces.

Suppose she picks “Yes”. Video 304 plays. During this, the video might ask her to do certain tasks. If she does so, she gets more gold.

In the above, she never explicitly uses the Reward Media Platform. She might not even know that it exists. The example in FIG. 3 is perhaps the simplest case. More complex interactions are discussed later. The scope of the invention is not limited to the specific example above and as those skilled in the art can appreciate, the scope of the invention can have many embodiments.

2] Supply

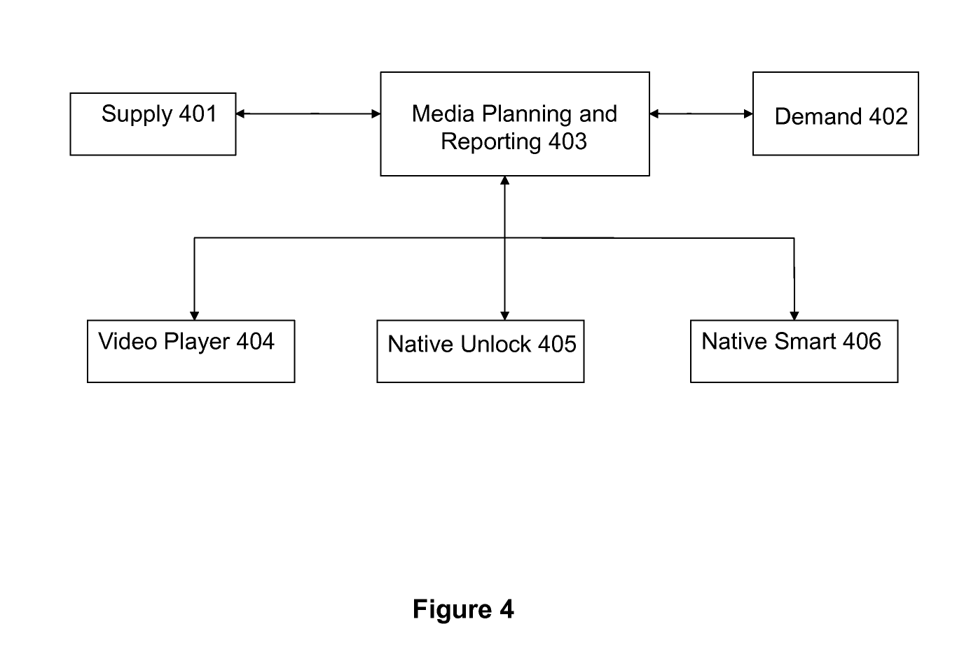

In FIG. 4, Supply 401 is the supply side marketplace of Content Creators and Publishers of mobile sites or apps or any publisher and any application that connects with the invention via the set of instructions and requirements for delivery mechanism. This includes any SDK, SSP, ad tag, or supply agent that applies the invention to any publisher through any method known or unknown.

The Supply marketplace has Audiences that visit its sites or use its apps. In general, these Audiences are different, though they might have non-zero overlap. In other words, users could visit several sites or use several apps.

FIG. 4 differs from FIG. 1, where the Reward Media Platform 103 could be considered a joint marketplace of Supply and Demand.

3] Demand

In FIG. 4, Demand 402 is the demand side marketplace of Content Creators that connects with the instructions of the invention. This includes any agent that generates an ad tag, operates any form of a media buying or media analytics dashboard such as a DSP, a Real Time Bidding platform, or SSP.

FIG. 4 differs from FIG. 1, where the Reward Media Platform 103 could be considered a joint marketplace of Supply and Demand.

4] Media Planning and Reporting

In FIG. 4, Media Planning and Reporting 403 is a component of the invention, which provides instructions and relevant tools to both the supply and demand marketplaces. It interacts with the components Video Player 404, Native Unlock 405 and Native Smart 406. It mediates the interactions of these components with the marketplace. The scope of the invention is not limited to games and as those skilled in the art can appreciate, the scope of the invention can have many embodiments. It is within the scope of the invention that the Media Planning and Reporting 403 could mediate interactions between various components and the marketplace.

One simple way that MPR 403 is accessed is as follows: a user uses her mobile device to play a game made by a publisher. The game is played as a native app. Though it might also be played as a non-native app, or played via a browser on the mobile device that accesses the game on the publisher's website. During the game play, the game contacts the publisher's game server. By assumption, the game can go out over the Internet to accomplish this. The server puts up a window on the mobile device. Normally, outside this submission, the window might have an ad with a link, where, if the user clicks it, this is considered a CPM action, and adds to the CPM count for that ad. Where one imagines that the ad is shown across various instances of this game and perhaps other games. The scope of the invention is not limited to the specific example above and as those skilled in the art can appreciate, the scope of the invention can have many embodiments.

Now, in one embodiment, when the user clicks the link, the game server calls MPR 403, which might be implemented as a Web Service. MPR 403 finds a video ad to be shown to the user of this game. For example, by the method of Section 1, at some earlier time, the advertiser who made this ad had picked this game to show the ad in, and purchased tokens from the publisher.

MPR 403 calls the various components in FIG. 4. So Native Unlock 403 is used to call Video Player 404, which then plays the video ad on the user device, such that if the user watches the ad to completion, she gets some amount of tokens usable in the game. If she only watches to some fractional stopping point in the video, like quartile marks, then she might get some proportional sub-quantity of tokens.

By this method, a traditional CPM action is automatically converted to a CPV action.

Media Planning and Reporting 403 offers the following new measurements:

A] An integrative or holistic media planning method and template for content creators to combine and distribute all relevant content. This includes click to play or autoplay video advertising, an external website or microsite, display advertising, video blog or news site, social network or social feed, or YouTube® channel, alternatively, any third party social video channel or direct response content such as a widget or rich media unit. Media Planning and Reporting 403 distributes the above through any mobile publisher in a manner, which appears as an appealing pathway of discovery natively through that publisher.

B] A method of targeting and acquiring online Audience for content, that delivers a high discovery efficiency and a high discovery appeal

C] A method of collecting data and reporting based on user behaviors, geographical location, demographics, and screen recordings, so as to deliver a new measurement—an ICF score, and a comprehensive report that introduces ‘Sensemaking’, an understanding of the cultivation of the new data and measurements.

D] A method which informs the context and requirements of the Video Player, Native Unlock and Native Smart.

The Media Planning and Reporting method is a process where:

A] The message of the Content Creator and any metrics for performance around a campaign are clear to the Content Creator. The performance metrics around any specific content in online media serves as a method of obtaining an Audience for that content, including but not limited to a visit to a website, signing up to a platform, online purchase, click through to a video or link through social recommendations, download of an app or participation, or sharing of any kind in any social media platform.

B] The message can be communicated through a conversion funnel—multiple media, multiple content, or multiple channels, such as paid display advertising, video, social media, public relations, apps, games or programs, or popular online ‘key influencers’ or ‘internet celebrities’, all of which need distribution.

C] The method teaches a discovery of content through the invention, to lead the online Audience down a path of discovery. This can generate a Key Performance Indicator, which the invention can distribute to the content creators.

D] The method teaches a ‘discovery efficiency’ where each instance of appealing discovery allows an easy navigation to the desired performance of an online user through a click, link, video, or action button, or a similar device available in the invention. Thus, requiring less time that a Demand or Supply Agent must invest in a campaign to acquire an Audience.

E] The method instructs that media planning can include all social, outreach and public relations Audience promotions that seek to ‘earn’ an Audience through appealing discovery and paid content buying. The method gives measurable performances.

F] The method introduces an ‘Official Social Host’ process where influential online users who are popular in social networks can be integrated into content campaigns along with a creator's content.

G] The method tells how to include any social video platform content for Audience acquisition.

H] The method shapes an online video promotional campaign into a process where behaviors across all channels in a campaign, such as paid media channels, social media channels, and public relations channels, are considered, along with screen and geographical data, in a way previously unavailable, and can now be compared to television media markets.

I] The method teaches the value of long term media planning, social and public relations outreach, and media buying, in various time scales, for example, by quarter, or annually. This permits collecting and developing, or acquiring and expanding an online Audience of users who have shared or participated in a content campaign, in such a way that the brand can re-message those quality users continually.

The method for data, new measurements and sensemaking, is defined as a process where:

A] The Click Through Rate (CTR) between all content accessed in the invention is recorded and measured as an ‘Impression Conversion Funnel’ or ICF score. It provides new data comparisons that show the efficacy of combining multi channel campaigns with a measurement of how appealing these are to online users.

B] The ICF score, solely through its inclusion in the invention, lets each CTR be classified as an ‘interested view’, ‘interested impression’, ‘interested sign up’, or ‘interested visit’, thus furnishing data specifically about the quality of the discovery of the content.

C] The segmentation of that data combined with geographical location, demographics, and screen or user discovery device data

D] The combination of such data gives a new understanding of the relevance of that data instantiated in a ‘sensemaking’ reporting template that details the above, segmented by each publisher the campaign was discovered on.

E] The collection from such viewers through tracking pixels (“web bugs”) or cookies that lets the method cultivate such viewers over time.

F] The methodology has the ability through combinations to deliver a clear amount of data, volume, and discovery more so than presently available. This data comparison can be offered as a comparison against Television Media Buying agents.

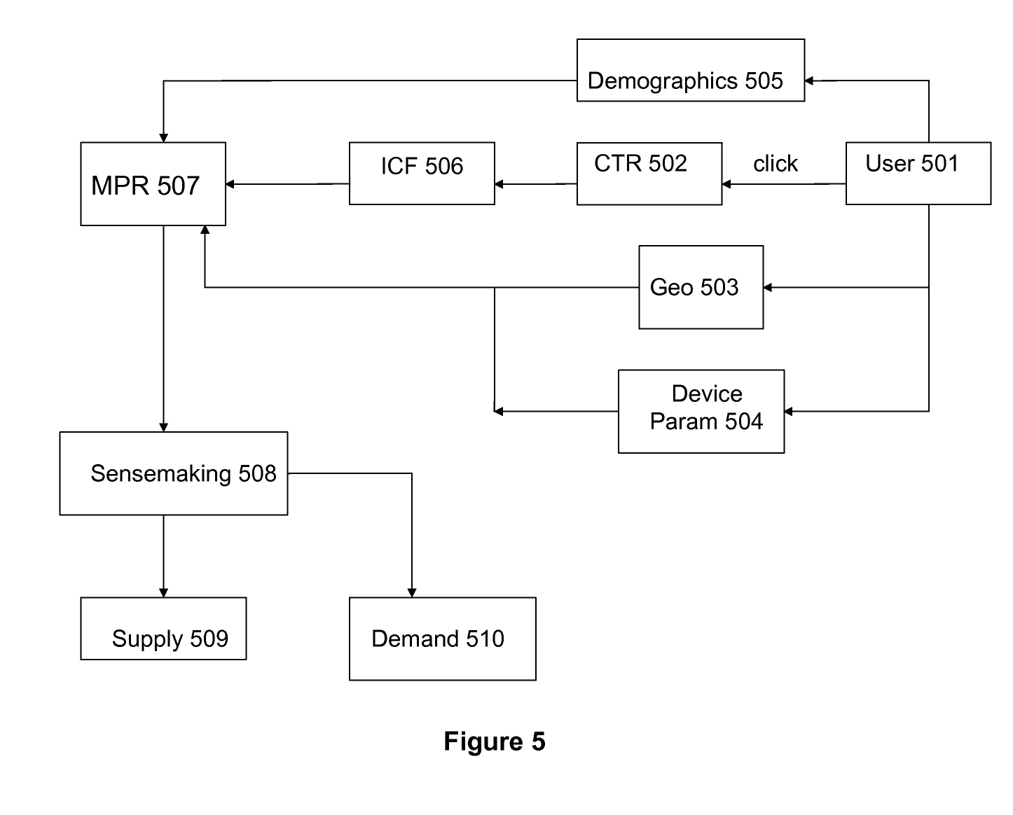

FIG. 5 describes a subset of the above. User 501 is a user viewing a web page on her device. If she clicks on a link, this makes click through rate CTR 502, which is transformed by the Media Planning and Reporting MPR 507 into ICF 506. For the purposes of clarity, ICF 506 is depicted outside MPR 507, to make clear the dependence of ICF 506 on CTR 502.

The user device might also have some geolocation information about itself. To the extent that this is accessible by MPR 507, module Geo 503 encompasses that data.

Also, the user device might let various information about itself be accessible online, for example its operating system type and version, or the resolution of its screen. All these are described in the module Device Param 504, which is used by MPR 507. The scope of the invention is not limited to the specific examples above, and as those skilled in the art can appreciate, the scope of the invention can have many embodiments. The user device might also expose demographic information about the user. This might be in the form of a cookie on the device browser. MPR 507 can use the cookie and external data sources to infer some demographic data.

MPR 507 feeds all these into Sensemaking 508 which can be accessed by Supply 509 or Demand 510. While perhaps for a specific web page that User 501 is looking at, only one of Supply 509 or Demand 510 might be interested in the user data, in general, across all users, entities in both Supply 509 and Demand 510 can use the Sensemaking 508 template.

A method for data processing systems or Media Dashboards, that is required and instructed to deliver data and analytics where applicable:

a] Analytics Reporting in real time

### b] Unit Impressions

c] Video initiations
d] Video completion rate
e] Bounce rate (percentage of users to visit a site and leave without doing anything)
F] CTRs, Clicks and user engagements, including but not limited to commenting, sharing, downloading.
G] Segmented data by publisher, device, browser, platform (desktop/mobile or any other Internet capable device) where applicable
H] Demographics where applicable
I] Geographic information, where applicable
J] Buy display inventory for mobile (apps and websites), social exchange (All value exchange inventory), desktop, native.
K] Post code targeting and DMA targeting
L] Cookie and retargeting capability: retargeting is from a list developed via this submission and from a list advertisers have from display buys.
M] Integrate with 3rd party data sources for compliance. These 3rd party targeting and ranking agents include Comscore Corp. and Nielsen Corp. The scope of the invention is not limited to the specific examples above, and as those skilled in the art can appreciate, the scope of the invention can have many embodiments.

Method and Instructions for Supply Side Content Creators:

a] Product is implemented via SDK, hard code or ad tag.
b] Load in content creators' and publishers' logo banners where applicable. For example, where the publishers' logo and brand are a component of the presentation of the UI and transforms the UI into a native page on a site or app.
c] Populate full screen either via, but not limited to, full screen pop up or full screen unit where applicable
d] Block content until a certain action is achieved (for example: watching 5 seconds of click-to-play video, 15 second preroll, social interaction, etc.) where applicable. In one embodiment, a publisher blocks access to that content until the viewer consumes a determined amount of time of advertising media.
e] Let a publisher customize the frequency of when the unit appears or does not appear.
F] Accommodate invention to publisher pricing floors or restrictions that are sold on a CPM
g] Allow publisher promotion within standard native advertising presentations, including making a native editorial page which features the product or any content contained therein.
h] Make available presentations for approval to publishers when required via the services of that method or supply platform
i] Identify publishers via their demographic and content category vertically (i.e. entertainment, sports, news, etc)

The scope of the invention is not limited to the examples above, and as those skilled in the art can appreciate, the scope of the invention can have many embodiments.

Method for Market Adoption:

The invention is unique in the sense that the adoption strategy of the invention on the marketplace resolves problems for those adopting it, in a way that informs sales processing.

A] By the invention's ability to convert CPM or Cost per Impression display buying, one to one without financial risk, into Cost Per View video media buying, content creators can increase the scale and scope of their ad campaign. Due to the removal of costs from risk mitigation, creating a large demand for invention via pricing alone.

B] Solely by this CPM to CPV conversion, content providers can exchange Audiences in a manner previously unavailable. By exchange Audiences, one means, for example, that users who visit a publisher site and click on a link (hence generating a CPM action), get a window where a video plays. By hopefully having the users watch some or all of the video, a CPV action can be generated.

C] The method resolves the two components of the supply and demand marketplace into one product. It also solves the market adoption problem that any invention faces on the marketplace. By definition, it is a sales method for any agent representing the invention on the marketplace.

5] Video Player

This is the module Video Player 404 in FIG. 4. An important special case of the Video Player is a basic video player, “Basic Player”, which can wrap any video, including YouTube videos, into an autoplay or ‘click-to-play view’ environment. This provides social sharing site call-ins and direct response objects. The objects appear upon video completion or any quartile completion of video, customizable overlays or video playlists. They can be embedded on to any desktop or mobile site. The player can record impressions to any page where the video is placed, as well as behavioral data such as clicks, session quartiles and completions, and sharing.

The choice of a quartile completion of video viewing means that the video in question, which is being seen by a user on her device, is divided into 4 equal duration segments. When the video reaches one of these quartile marks, then the wrapping control software of the Video Player can present a direct response object on her device.

The choice of quartile periods is within the discretion of the publisher or Supply and Demand Agents. Other number of segments can be chosen. Also, for simplicity, for quartile or other number of segments, each segment is assumed to be of equal duration. Different length segments are possible in the scope of this invention.

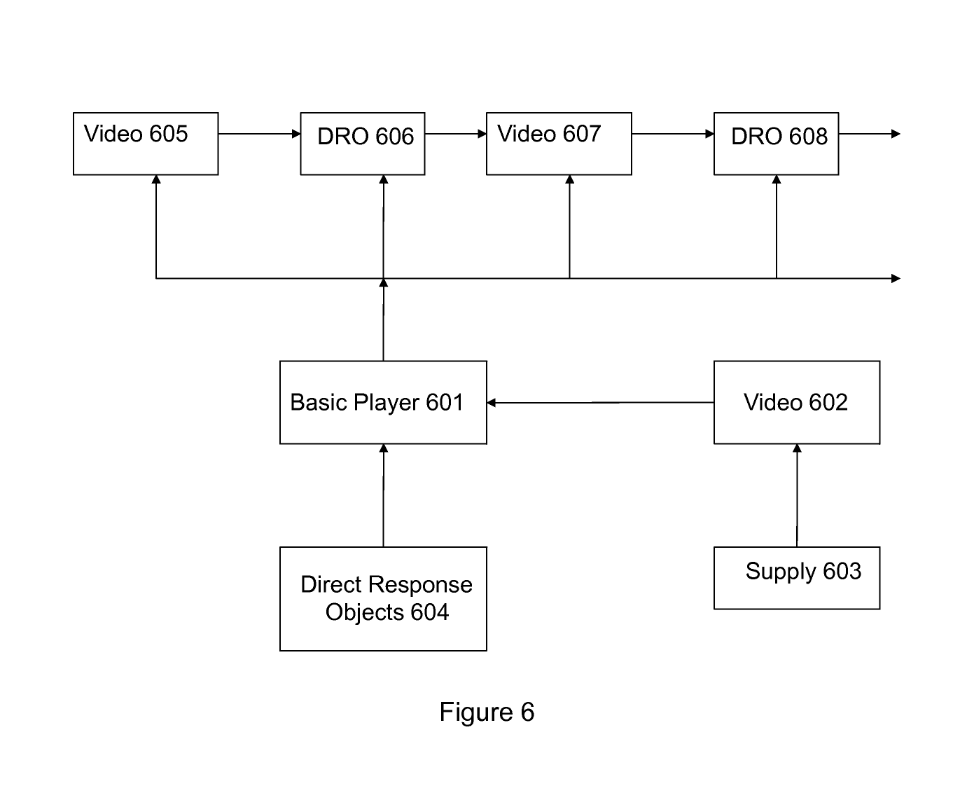

FIG. 6 shows a Basic Player 601, which gets the input of Video 602 from a supplier, Supply 603. The latter is equivalent to Supply 401 in FIG. 4. Basic Player 601 makes Direct Response Objects 604. Then it makes and plays the first video segment of Video 602, as Video 605. Followed by DRO 606, which is a Direct Response Object. Here, the user might do some interaction with DRO 606. Then Basic Player 601 plays Video 607, which is the second video segment of Video 602. Followed by the playing of DRO 608; and so on, until the completion of the video.

FIG. 6 is for the case where the original video is segmented and Direct Response Objects are played at the end of each segment, instead of the case where video is played unaltered, and only one Direct Response Object is shown, at the end of the video.

FIG. 6 shows Direct Response Objects 604. In contrast with Video 602, which comes from a source (Supply 603) external to Basic Player 601, item/s 604 would typically be generated inside 601. Further, it is possible that given the sequential time flow at the top of FIG. 6, that only one DRO item need exist at any given time.

Also, in general, if several DROs were to appear during the playing of a video, they might differ from each other. At the simplest level, each DRO would at least have some indicator of how far into the video the user is at. Like the depiction of a progress bar, showing 25%, 50%, 75% and 100% completion, if quartile divisions of the video are done. The scope of the invention is not limited to the specific examples above, and as those skilled in the art can appreciate, the scope of the invention can have many embodiments.

The Video Player has one or more of the following properties. It is recommended that any instantiation implements as many of these as possible, to maximize the usefulness of the module:

A] HTML 5 video player for multi screen adoption
B] play/pause button or auto-play feature
C] scroll bar for toggling
D] exit to full screen function
E] an overlay option customizable for brand identity
F] ‘Share’ buttons so video location can be shared on social networks such as Facebook, Twitter, Google Plus, and others that exist or may be developed.
G] Video carousel option for video playlists.
H] Can accommodate any resolution, aspect ratio, and dimension for any advertising, social, or PR placement.
I] Upon any session length of the video or at its completion, the video player can automatically generates a customized sharing object for social sharing.
I.1] This sharing object is the property of the video player. It has a customizable message and is presented in the boundaries of the social network brand that it's designed to call in.
I.2] This sharing object is initiated by the video player that has the customizable message. If the user picks a ‘click to share’ function, then it calls in the formal sharing object of that social network and publishes the social message automatically.
J] Upon completion of a segment of the video, a customizable overlay can appear for the purposes of any direct response, click through or call through.
K] The Basic Player can record in screen engagements, such as sharing, commenting, or voting in unit.
L] The Basic Player can segment session length by quartile or better.
M] The Basic Player can be embedded or shared either as an ad unit through an ad tag, or as a video player that can be embedded by content authors or outreach agents on blogs and forums.
N] The Basic Player can count impressions on any page that accommodates its location, blog, social sharing, or ad unit.
O] The Basic Player can call in any media advertising serving technologies such as VAST tag, VPAID tag or any other ad tag that serves video or other ads.
P] Provide call back keys for token exchanges on reward media platforms.

The scope of the invention is not limited to the specific examples above, and as those skilled in the art can appreciate, the scope of the invention can have many embodiments.

Instructions and Requirements

The Media Buying Dashboard or SDK can implement data segmentation and data targeting and needs to accommodate the following instructions:

A] Basic Player can accommodate URL attribution direct from publisher.
B] Basic Player can provide screen segmentation, i.e. user's desktop, device, or browser.
C] Basic Player can deliver geographical information of the user location.
D] Basic Player can integrate with all major third party data agents in compliance, targeting, and ranking.
E] Basic Player can collect first party data where applicable. Basic Player can accommodate segment and tracking pixels or cookies across screens where applicable for the purposes of retargeting and re-messaging.
F] Collect and segment user data and deliver reporting for Sensemaking.
G] Provide call back keys for token exchanges on reward media platforms

6] Native Unlock

This is module Native Unlock 405 in FIG. 4. It has the following properties:

A] Native Unlock may call the Video Player module or any other video unit that can be served or hosted. Optimally, the Video Player does not take up to the entire page. For example, the video player may be limited to no more than 50% or some other amount of the page space, allowing additional invention features to be presented. The scope of the invention is not limited to the specific example above, and as those skilled in the art can appreciate, the scope of the invention can have many embodiments.

B] Native Unlock is designed for a full screen viewer experience for either a full page interstitial or full screen pop-up page that is generated on any mobile publisher site. It may be locked to either a vertical setting on the screen or device or a horizontal dynamic setting, depending on the instructions of the method and content creator requirement.

C] Native Unlock might show a Publisher heading and or customized branding, on the top, middle, or bottom of player, or any other information desired by the publisher.

D] Native Unlock may lock the screen with a timer until the user clicks the video unit play button and watches for a minimum time (for example, five seconds) and then unlocks the screen by highlighting that viewer's return to page or content of interest.

E] Native Unlock may take the viewer's intended URL location on publisher and may highlight the link for easy viewer navigation to that page after unlocking

F] Native Unlock may pull an URL automatically from any publisher page location that discovery of Native Unlock occurred. It may attribute that URL to the view on the video to content creator.

G] The unit could then deliver a call to action message “Press Play to Continue” or equivalent in English or any language to the viewer, showing the unlock option.

H] Native Unlock can convert CPM (impression) quantities into CPV (video view) neatly and as close to a one to one mapping as possible. Every viewer impression could convert to a video view. This allows high CPM payout to the publisher and low CPV cost to the demand agency.

I] Native Unlock could be full screen and could let any customization appear as a publisher ‘native’ page. This lets the publisher maintain a consistent user interface and branding.

J] Native Unlock can call in the publisher URL as the attribution source for the video view and any player that is hosted, such as YouTube®. It could record the publisher URL as the attribution source.

K] Native Unlock can provide call back keys for token exchanges on reward media platforms.

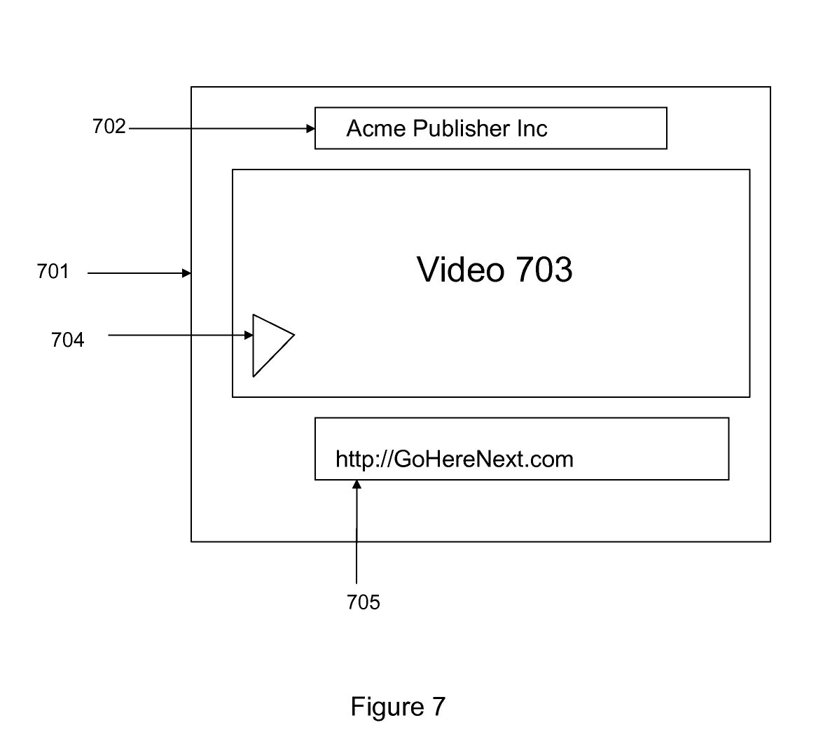

FIG. 7 shows a simple instantiation of Native Unlock on a user device screen 701. Item 702 is a label area where a publisher's label or title can be put, so that the user can be aware of the publisher's brand. The section Video 703 is where the Video Player is used to play the desired video.

Item 704 is the play/pause button. Note that this is part of the Video Player. Currently, the video is paused, so that the button depicts “play” as the action that would happen if the user pressed it. Item 705 shows the URL of the viewer's intended URL location.

Instructions for Native Unlock

A] A mobile site or mobile app can use any accompanying SDK that integrates Native Unlock. Using any API that services its adoption, or by hard coding into any platform, or being served through any RTB that connects to the invention.

B] Native Unlock can integrate with any native discovery option or publisher click or link. It can also integrate with any Native Advertising presentation on the marketplace. Specifically a Native impression of branded content served via the native content feed of any publisher that links to a landing page URL dedicated to that particular brand of content that functions as a native editorial article on any publisher.

C] Native Unlock can allow customization for the publisher or demand client, for any extra information or content links, where relevant, alternatively, it may pull any publisher feed or content into the invention for user discovery in the product unit.

D] Content provider Heading in Unit can be instructed to be proportional to the presentation as a user feature and UI of the product. It can instruct and require publisher participation and opt in.

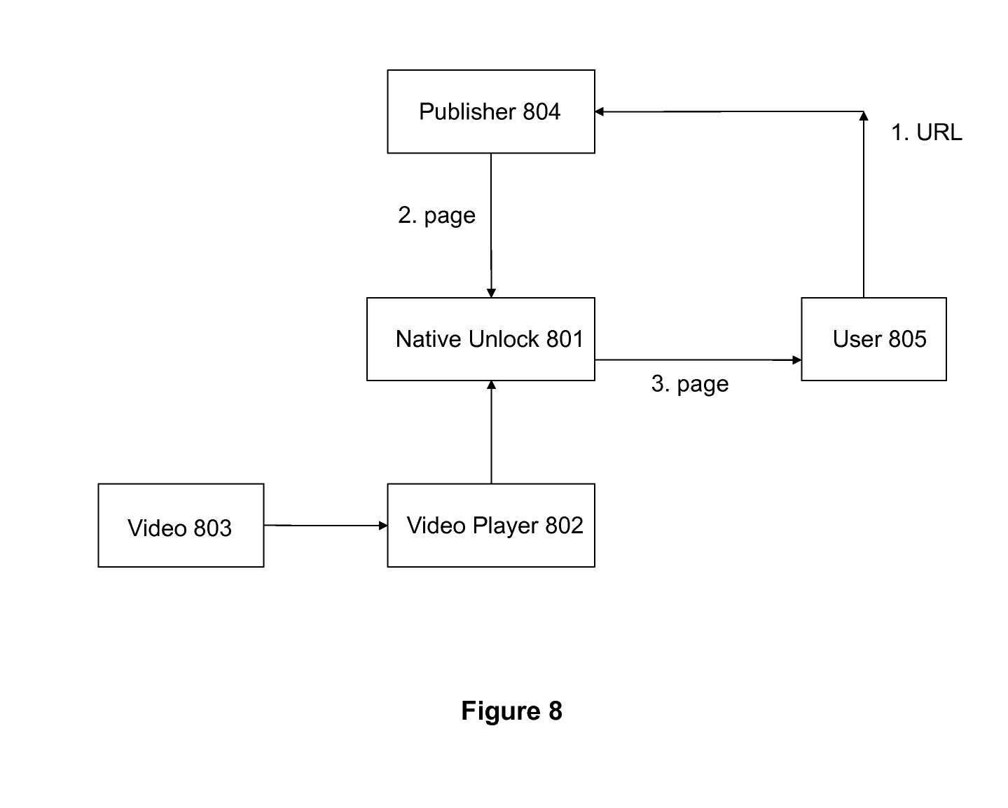

FIG. 8 shows Native Unlock. But whereas FIG. 7 depicted a possible screen and the graphical user interface that the user would see, FIG. 8 is a block diagram of one possible implementation of Native Unlock, interacting with external elements. User 805 clicks on an URL, which points to a domain controlled by Publisher 804. This is depicted by the arrow with the label “1. URL”. Publisher 804 then sends the page referred to by the URL to Native Unlock 801. The latter accesses Video Player 802. Other screen and graphical user interfaces are apparent to those skilled in the art and are within the scope of the invention.

Video Player 802 uses this page, and embeds Video 803 in a popup and sends the resultant page and popup to Native Unlock 801, which in turn sends it to User 805. The latter is indicated by the label “3. page”. This page will be different, in general, from “2. page”.

Also, for brevity in the label “3. page”, it omitted explicit mention of the popup made by Video Player 802 and Native Unlock 801.

In some implementations, Video 803 could also come from Publisher 804. But FIG. 8 treats the more general case. Where Video 803 might be an ad, for example, that comes from an advertiser who is different from Publisher 804. The scope of the invention is not limited to the specific variations in implementation discussed above, and as those skilled in the art can appreciate, the scope of the invention can have many embodiments, all of which are within the scope of the invention. The reader should note that the numbering in the 3 labels for the arrowed lines, from 1 to 3, indicates the time sequence of events. Deliberately, the arrows from Video Player 802 and Video 803 are not in this sequence. One reason could be that Video Player 802 might be pre-loaded by Native Unlock 801 into its memory.

Likewise, the ad Video 803 might be already preloaded into the memory of Native Unlock 801. One reason could be that Video 803 might be shown in a blocking popup, for any URL that User 805 sends to Native Unlock 801.

7] Native Smart:

This is the module Native Smart 406 in FIG. 4. It adds multichannel distribution of the conversion funnel into an appealing discovery.

A] Native Smart is a unit that is one embodiment of all aspects of the invention.
B] It can include any of the capabilities of the Video Player and Native Unlock.
C] It can include the conversion funnel designed for the method of the Media Planning and Reporting and present multiple conversions in each instance.
D] It can distribute multiple videos either on auto play or click to play formats.
E] It can call in a mobile site of a publisher and present the site in this invention for easy user navigation, allowing the equivalent of mobile web browser capabilities inside the invention.
F] It can call in any Social Video or social video-sharing channel in unit for easy user navigation.
G] It can call digital coupons for user acquisition.
H] It can call in any social network feed or widget.
I] It can call in any rich media unit.
J] It can call in any direct response form, survey, or sign up.
K] It can call in any installation or download function.
L] It can call in any known or unknown form of mobile media that is hosted on the web and whose API allows for such.
M] It contains all the native properties for presentation or discovery as Native Unlock.

8] Extensions:

Consider again FIG. 4 and its modules. One case is where the controlling Media Planning and Reporting module accesses the other modules, where one or more of the latter are made by independent organizations. The modules would communicate across the Internet. From a programming standpoint, this can be done if Application Programming Interfaces [APIs] were defined. Such that any Video Player, Native Unlock or Native Smart instantiations satisfied those APIs. Letting the Media Planning and Reporting access and possibly control those via the APIs.

Also, suppose the Video Player 404 is made by a different organisation. There might be different Video Players, where all satisfy the Video Player API. Each might specialise in different things. The controlling Media Planning and Reporting module would have some rules to pick a given Video Player. Depending perhaps on such parameters as the properties of the user's device.

To wit, a given Video Player might be optimised for a specific mobile phone. While another Video Player might be optimised for a standard desktop screen and desktop operating system.

The present invention accordingly comprises the features of construction, combination and arrangement of elements, as well as the several steps and the relation of one or more of such steps with respect to each of the others, all as exemplified in the above detailed disclosures, and the scope of the invention will be indicated in the claims.

It should be appreciated that the aspects, features and advantages made apparent from the foregoing and the accompanying detailed descriptions are efficiently attained and, since certain changes may be made in the disclosed constructions and processes without departing from the scope and spirit of the invention, it is intended that all matter contained herein and in the accompanying detailed description shall be interpreted as illustrative and not in a limiting sense.

It is also to be understood that the following claims are intended to cover all of the generic and specific features of the invention described is this specification and claims, and all statements of the scope of the invention, which as a matter of language, might be said to fall between those features and statements.

I claim:

1. A data processing system where a publisher furnishes a link to an application that the publisher makes available on the Web;
where the publisher furnishes information about tokens used in the application;
where a content creator purchases a quantity of tokens from the publisher;
where the content creator furnishes a link to a video made by the content creator;
where the content creator associates selected ones of the purchased tokens with a video;
where a user uses the application on an electronic device and receives a first portion of tokens from the system;
where a window appears in the application;
where the video plays in the window;
where when the user watches the video to completion, the user receives a second quantity of tokens from the system;
where the user can use the second quantity in the current application.

2. The method of claim 1, where the user can use the second quantity in a later use of the application.

3. The method of claim 1, where the application can have multiple types of tokens.

4. The method of claim 3, where, when the user has watched the video to completion, he can choose different quantities of each type of token.

5. The method of claim 1, where the application is a game.

6. The method of claim 1, where the user can stop viewing the video at locations in the video pre-determined by the content creator.

7. The method of claim 6, where if the user stops viewing prior to the end of the video, he gets a third quantity of tokens, where the third quantity is less than the second quantity.

8. A data processing system configured to exchange Audience data and content between Publishers, Demand and Supply Agents, and Content Creators, comprising:
A data storage unit which includes data about:
(a) at least one video player program for distribution;
(b) content selected from at least one of click-to-play video, auto-play video, click-to-play tag, auto-play tag;
(c) value exchanges between at least two of users, publishers, and creators, said value exchanges comprising at least one of call back keys, or content unlock features;
(d) at least one multiple-content channel including a video play, and at least one of a direct response form, a social network, a website, or a coupon, to be featured along with the video play; and
(e) at least one of a social sharing feature or an overlay window, said features or windows occurring during or at the end of the video play;
wherein the system generates information about Audience behavior and reports that Audience behavior information to at least one of the Publishers, Supply or Demand Agents, or Content Creators.

9. The system of claim 8, where the Audience information is selected from at least one of:
a. a Universal Resource Locator (URL) of a publisher, where the URL points to a page, or a predecessor of a page, where the video player was discovered by the Audience;
b. data generated from Audience's unlocking content on a web page;
c. publisher data;
d. data from a source other than Publishers and Content Creators;
e. behavior of the audience discovering content, where additional information is reported to Publishers or Content Creators.

10. The system of claim 9, where said Audience information is selected from an Impression Conversion Funnel score; wherein the Impression Conversion Funnel combines result data selected from at least two of paid display advertising, video, social media, online applications or computer games.

11. The system of claim 9, where data is used for a token marketplace;
where tokens are sold by Publishers;
where tokens are bought by Content Creators.

12. The system of claim 9, where a computer module (“Native Unlock”) is invoked by a publisher application running on a user device;
where the module invokes a video player optimized for the user device;
where the video player plays a video from a content creator; and
where the module lets the Audience stop watching at pre-determined locations in the video.

13. A data processing system comprising a data storage unit with data about:
(a) at least one video player program for mobile or desktop distribution;
(b) any click-to-play or auto play video or tag;
(c) value exchanges between users, Web publishers and Web creators, said value exchanges comprising call back keys, or any content unlock features;
(d) at least one multiple-content channel including at least one of a direct response form, a social network, a website, or a coupon, to be featured along with the video play; and
(e) social sharing features or overlay windows occurring either during or at the end of the video play, where the system gathers information about audience behavior.

14. The system of claim 13, where the System is configured to allow Publishers and Content Creators to exchange data.

15. A method of providing at least one of Content Creators, Publishers, Supply and Demand Agents, Audience data, wherein the method comprises the steps of obtaining content, making it available to the Audience, generating Audience data and supplying the Audience behavior information to at least one of the Publishers, Supply or Demand Agents, or Content Creators.
